(19) United States
(12) Patent Application Publication
(10) Pub. No.: US 2026/0030572 A1
(43) Pub. Date: Jan. 29, 2026

(54) SYSTEM AND METHOD FOR DYNAMIC SCHEDULE DATA AUGMENTATION

(71) Applicant: Zebra Technologies Corporation, Lincolnshire, IL (US)

(72) Inventors: Yuling Gu, Lincolnshire, IL (US); Jay J. Williams, Glenview, IL (US); Abdalkarim Mohtasib, Lincoln (GB); Navid Ehyaee, Atlanta, GA (US)

(21) Appl. No.: 18/785,448

(22) Filed: Jul. 26, 2024

(51) Int. Cl. G06Q 10/0631; G06Q 10/1093

(52) U.S. Cl. CPC G06Q 10/063116; G06Q 10/1097

(57) ABSTRACT

A method in a computing device includes: obtaining schedule data for a facility, the schedule data including a plurality of segments, each segment having (i) a start time, (ii) an end time, and (iii) a worker identifier assigned to the segment from a plurality of worker identifiers; obtaining presence data including, for each of the plurality of worker identifiers, whether a corresponding worker is present at a facility; detecting, from the presence data, a worker present at the facility, having a first worker identifier that is not assigned to any of the segments in the schedule data; generating an auxiliary segment having (i) a start time based on the presence data, (ii) an end time based on a comparison of the schedule data with the presence data, and (iii) the first worker identifier; and providing the auxiliary segment to a task allocator with the schedule data.

### BACKGROUND

The operation of facilities such as retailers, warehouses, and the like, may involve the performance of a wide variety of tasks by staff at such facilities. Unpredictable variations in available staff can complicate the allocation of tasks to staff, and may render automatic task allocation computationally intractable.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for automated task allocation in a facility.

FIG. 2 is a diagram of certain internal components of the computing device of FIG. 1.

FIG. 3 is a flowchart of a method of dynamic schedule data augmentation.

FIG. 4 is a flowchart of a method of determining end times for dynamically generated auxiliary schedule segments in the method of FIG. 3

FIG. 5 is a diagram illustrating an example performance of the method of FIG. 4.

FIG. 6 is a diagram illustrating another example performance of the method of FIG. 4.

FIG. 7 is a diagram illustrating a further example performance of the method of FIG. 4.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device including: obtaining schedule data for a facility, the schedule data including a plurality of segments, each segment having (i) a start time, (ii) an end time, and (iii) a worker identifier assigned to the segment from a plurality of worker identifiers; obtaining presence data including, for each of the plurality of worker identifiers, whether a corresponding worker is present at a facility; detecting, from the presence data, a worker present at the facility, having a first worker identifier that is not assigned to any of the segments in the schedule data; generating an auxiliary segment having (i) a start time based on the presence data, (ii) an end time based on a comparison of the schedule data with the presence data, and (iii) the first worker identifier; and providing the auxiliary segment to a task allocator with the schedule data.

Additional examples disclosed herein are directed to a computing device including: a communications interface; and a processor configured to: obtain schedule data for a facility, the schedule data including a plurality of segments, each segment having (i) a start time, (ii) an end time, and (iii) a worker identifier assigned to the segment from a plurality of worker identifiers; obtain presence data including, for each of the plurality of worker identifiers, whether a corresponding worker is present at a facility; detect, from the presence data, a worker present at the facility, having a first worker identifier that is not assigned to any of the segments in the schedule data; generate an auxiliary segment having (i) a start time based on the presence data, (ii) an end time based on a comparison of the schedule data with the presence data, and (iii) the first worker identifier; and provide the auxiliary segment to a task allocator with the schedule data.

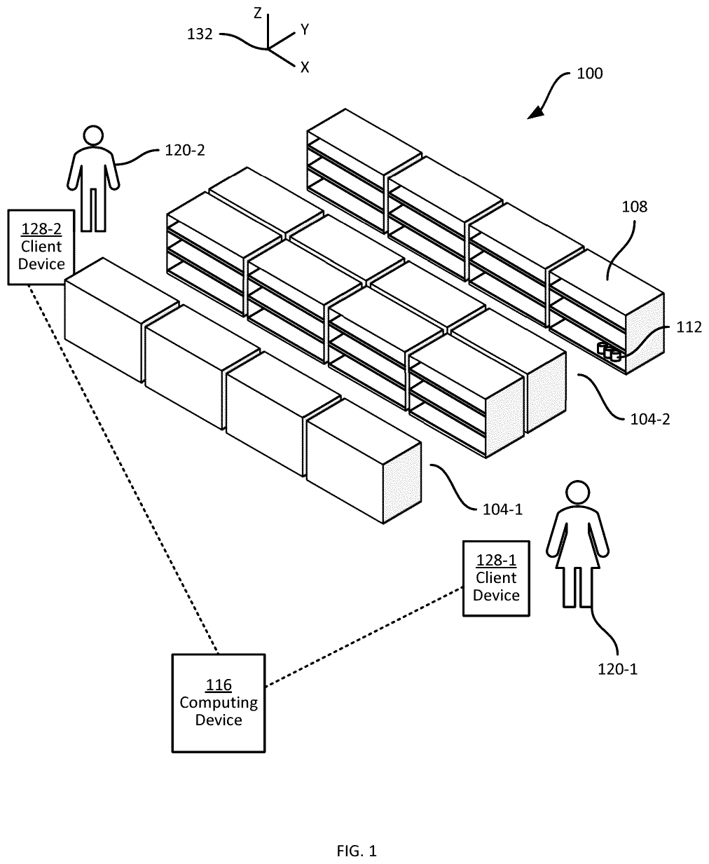

FIG. 1 illustrates a system 100 for automated task allocation in a facility, such as a retail facility (e.g., a grocer) containing one or more aisles 104-1, 104-2 (also referred to collectively as aisles 104, or generically as an aisle 104; similar nomenclature may also be employed herein for other elements with reference numbers with hyphenated suffixes). The aisles 104 can be formed, as in the illustrated example, by support structures such as shelf modules 108, each defining one or more support surfaces (e.g., shelves, peg boards, or the like) for supporting items 112 such as products available for purchase by customers of the retail facility. The system 100 can be deployed in a wide variety of other facilities, including manufacturing facilities, healthcare facilities, warehouses, and the like.

The system 100 includes a computing device 116 configured to obtain task records that define tasks to be performed in the facility, and to allocate the tasks to workers, such as example workers 120-1 and 120-2 shown in FIG. 1, deployed in the facility to perform the tasks. While FIG. 1 illustrates two example workers 120, facilities can include a variety of numbers of workers, including tens, hundreds, or thousands of workers in some systems. In some examples, the workers deployed in the facility can also include semi-autonomous or autonomous robots, in addition to or instead of the human employees shown in FIG. 1. Although two workers 120 are shown in FIG. 1, the facility can include a plurality of workers 120 deployed therein. The number of workers 120 deployed in the facility at a given time can vary, and may be determined according to a previously-generated schedule. As discussed below, a schedule can define a plurality of segments, which may also be referred to as shifts, for each of a plurality of days. Each segment is defined by a start time and an end time (e.g., a shift may begin at 8 am on a given day and end at 2 pm on the same day). Each segment is also defined by a worker identifier, corresponding to one of the workers 120. A segment, in other words, defines a period of time that a particular worker is expected to be present at the facility and thus available to perform tasks.

The tasks allocated to the worker(s) 120 can vary with the nature of the facility. For example, tasks allocated to workers 120 in a retail facility as shown in FIG. 1 can include cleaning tasks (e.g., to clean a spill in an aisle 104), stock picking tasks to collect items 112 for order fulfillment, replenishment tasks to retrieve items 112 from a storage area (not shown) for placement on the shelf modules 108, and the like. The workers 120-1 and 120-2 can carry or otherwise access respective client computing devices 128-1 and 128-2, such as smart phones, tablet computers, or the like, in communication with the computing device 116.

Each of the client devices 128 can track their locations in the facility, for example, according to a coordinate system 132 established in the facility. The client devices 128 can be configured to report tracked locations to the computing device 116, for use in task allocation functions performed by the computing device 116. In some examples, the system 100 can also include sensors such as wireless beacons or the like in communication with the computing device 116, that the computing device 116 can communicate with to determine locations of the client devices 128.

The computing device 116 is configured to receive task records defining tasks to be performed in the facility. The task records can be created, in some examples, by operators of the system 100 such as the workers 120. For example, in response to detecting or otherwise becoming aware of a spill in an aisle 104, a manager of the facility, a worker 120, or the like, can submit a task record to the computing device 116, either via direct interaction with the computing device 116, or via a client device 128. The computing device 116 can be configured to select one or more workers 120 to perform the task (also referred to as allocating the task to that worker 120 or those workers 120), and to transmit the task record to the selected worker(s) 120, e.g., via the corresponding client device(s) 128.

Allocating a task to one of a number of available workers 120 can be dependent on a wide variety of factors. Among those factors are the location of the task and the distance from that location to each of the available workers, and the skills, certifications, or other attributes involved in performing the task. Other factors upon which task allocation can depend include the expected duration of the task and the period of time for which each worker 120 is expected to remain available at the facility. The device 116 can employ the schedule mentioned above as an input to a task allocation process, e.g., to determine which workers 120 are both currently present in the facility, and expected to remain present in the facility for a sufficient period of time to complete the task. For example, allocating a task with an expected duration of two hours to a worker 120 whose shift is scheduled to end in thirty minutes may be suboptimal, as the worker 120 may leave the facility before the task is complete, which may lead to the task (or a portion thereof) being re-allocated to a different worker 120.

While the device 116 can determine how long some workers 120 are expected to be available based on schedule data, in some cases a worker 120 is present at the facility but does not appear on the schedule. For example, a first worker 120 with a shift on a given day may have called in sick, and a second worker 120 may have been asked to cover the first worker's shift. In another example, two workers 120 may have swapped shifts. In still further examples, a worker 120 may be working an unscheduled shift to account for unexpected workload at the facility, or the like. A wide variety of reasons may lead to a worker 120 being present at the facility on a given day without appearing on the schedule.

The above scenarios may not be reflected in the schedule due to the timing of the conditions specified in each scenario. For example, a schedule for a given day may be generated days or weeks in advance (e.g., of a given day). The scheduling process may be sufficiently complex and/or time-consuming that modifying the schedule once it has been generated is difficult. When events such as those set out above occur within a comparatively short time period before the day represented by the schedule (e.g., one day before or less), modifying the schedule may not be feasible. When a worker 120 is present at the facility, but is not represented in the schedule data obtained by the device 116, the device 116 may be unable to automatically allocate tasks to that worker 120, or if automatic allocation is performed, may make suboptimal allocations. Allocating tasks to that worker 120 may therefore fall to a human manager to subjectively allocate tasks to the workers 120.

The device 116 is configured, as described below, to perform certain functions to facilitate the automatic allocation of tasks to unscheduled workers 120 (e.g., workers 120 present at the facility despite not being assigned to any shifts in the current schedule). The functions implemented by the device 116 can thus permit the device 116 to perform new functionality that was not previously feasible to automate.

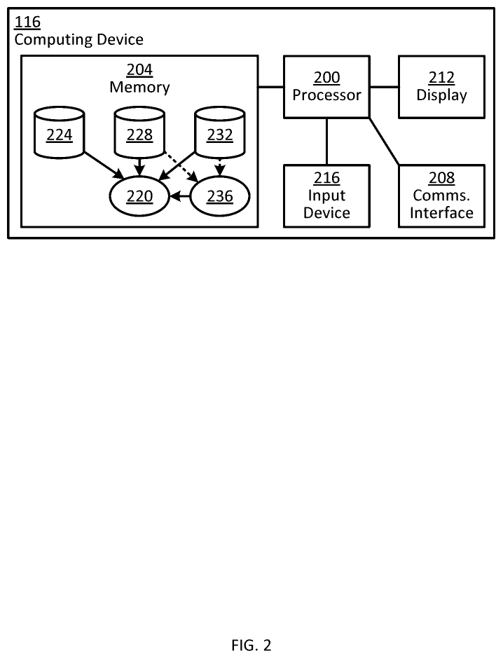

FIG. 2 is a diagram of certain internal components of the computing device 116. The computing device 116 includes a processor 200 (e.g., a central processing unit (CPU), graphics processing unit (GPU), and/or other suitable control circuitry, microcontroller, or the like), interconnected with a non-transitory computer readable storage medium, such as a memory 204. The memory 204 includes a suitable combination of volatile memory (e.g. Random Access Memory or RAM) and non-volatile memory (e.g. read only memory or ROM, Electrically Erasable Programmable Read Only Memory or EEPROM, flash memory). The memory 204 can store computer-readable instructions, execution of which by the processor 200 configures the processor 200 to perform various functions in conjunction with certain other components of the computing device 116. The computing device 116 also includes a communications interface 208 enabling the device 116 to exchange data with other computing devices, e.g. via a wireless local area network deployed in the facility, a combination of local and wide-area networks, and the like.

The device 116 can also include a display 212 and/or other suitable output device, such as a speaker, and an input device 216 such as a keyboard, a mouse, a microphone, and/or other suitable inputs. In other examples, the display 212 and input device 216 are hosted by a separate computing device (not shown), and connected to the computing device 116 via a network and the communications interface 208.

The components of the computing device 116 can be supported in a housing deployed at the facility of FIG. 1, e.g., as a desktop computer, on-site server, or the like. In other examples, the computing device 116 can be implemented in cloud infrastructure, e.g., as a virtual machine executed on computing hardware shared between various other functions.

The instructions stored in the memory 204 include, in this example, a task allocation application 220 that, when executed by the processor 200, configures the device 116 to obtain task records corresponding to tasks to be performed at the facility and worker profiles corresponding to workers deployed in the facility to perform tasks, and to allocate the tasks to the workers.

The memory 204 can also store data employed during execution of the application 220 to allocate tasks. As shown in FIG. 2, the memory 204 can store a task repository 224, containing task records that define tasks to be performed in the facility of FIG. 1 (or any other suitable facility). Data defining a task can include a task name or instruction (e.g., open a cashier, clean a spill, restock an item 112, or the like), an expected task duration, and a task priority (e.g., from critical or high-priority to best-effort or low priority, traversing any suitable number of graduations). Other data defining a task can include skill requirements for performing the task (e.g., a forklift operator certification), a task location (e.g., coordinates in the system 132 and/or identifier of an aisle 104), and the like.

Any given task record can also contain metadata associated with the task, such as an identifier of a worker allocated to the task (if the task has been allocated), and/or timestamps indicating one or more of when the task was generated, when the task was allocated, when the task was completed, and the like. Other metadata that can be stored with a task can include a percentage or other fraction of completion of the task, e.g., obtained after the task has been allocated to a worker.

The memory 204 can also store a worker profile repository 228, containing worker profiles each corresponding to a worker 120 in the facility. Each worker profile can include, for example, an identifier of the corresponding client device 128. The identifier can include a network identifier such as an IP address, a media access control (MAC) address, an account name, or the like. Each worker profile can also include identifying information such as a name, as well as a worker skill set (e.g., certifications, authorization levels, and the like), and a worker location within the facility (which may be periodically updated). Each worker profile can also include an activity indicator, corresponding to whether or not the worker is currently performing a task. In some examples, a worker profile can also include presence data, indicating whether the worker is signed in, online, or the like, at the facility. Presence data, that is, indicates whether a worker 120 is available for task allocation. The presence data can indicate, in some examples, an arrival time and (when applicable) a departure time for the corresponding worker 120, for the current day. Such presence data can be obtained by the device 116 from a timekeeping system that tracks clock-in events indicating that workers 120 have arrived at the facility (or returned from breaks, or the like), and clock-out events indicating that workers have left the facility (or gone on breaks, or the like). In some examples, presence data can be stored separately from the worker profile repository 228.

The memory 204 can also store a schedule repository 232, containing schedule data, e.g., for at least the current day (or other suitable time period). As noted above, the schedule data can define a plurality of segments or shifts, each defined by a start time, an end time, and an assigned worker identifier. The application 220, as indicated by the arrows in FIG. 2, can obtain data from each of the repositories 224, 228, and 232, to determine task allocations.

The memory 204 can further store an unscheduled worker handling application 236. In other examples, the application 236 can be a component of the application 220, but is illustrated separately in this example for clarity. The application 236 is configured to retrieve schedule data and presence data (e.g., from the repositories 232 and 228, respectively), and to generate auxiliary segments or shifts, which may also be referred to as virtual segments or shifts, corresponding to unscheduled workers 120. An auxiliary segment is not included in the schedule data, but rather is dynamically generated by the application 236, and provides the application 220 with start and end times for a worker 120 who is present at the facility, but does not appear in the schedule.

By dynamically augmenting the schedule data, e.g., injecting auxiliary segments to the application 220, e.g., in the same format as the schedule data from the repository 224, the application 236 can permit the application 220 to automatically allocate tasks to unscheduled workers, rather than having such task allocations performed manually based on subjective human judgement. Further, the generation of auxiliary segments and provision of such segments to the application 220 by the application 236 may permit the above extension of automatic task allocation functionality, while mitigating or avoiding modifications to the schedule data stored in the repository 228 and the system(s) configured to generate such schedule data.

The device 116 and the applications 220 and/or 236 may be referred to in the discussion below as being configured to perform various actions. It will be understood that such references indicate that the device 116 is configured to perform those actions via execution of the relevant one(s) of the applications 220 and/or 236 by the processor 200. Further, while the applications 220 and 236 are described above as executable software applications, in some examples, either or both of the applications 220 and 236 can be implemented in hardware, e.g., as application-specific integrated circuits (ASIC) or the like.

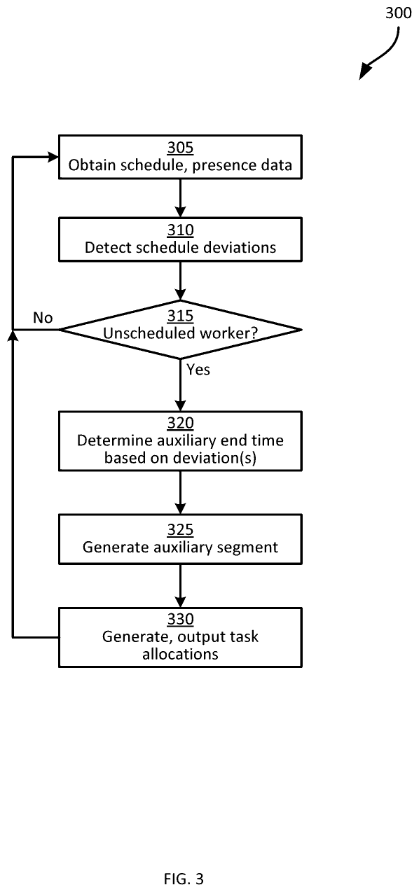

Turning to FIG. 3, a method 300 of dynamic schedule data augmentation is illustrated. The method 300 is described below in conjunction with its performance by the device 116, via execution of the application 236 (or if specifically noted, the application 220) by the processor 200.

At block 305, the device 116 is configured to obtain schedule data, e.g., from the repository 232, and presence data, e.g., from the repository 228. The schedule data obtained at block 305 includes each shift, e.g., for the current day, or another suitable time period. The presence data obtained at block 305 also includes presence data for the current day (that is, any arrival and/or departure times for each worker 120 that are within the current schedule period, such as one workday).

At block 310, the device 116 is configured to detect zero or more schedule deviations. A schedule deviation is a mismatch between the presence data and the schedule data, and the device 116 is thus configured to perform block 310 by comparing the presence data with the schedule data. The device 116 can be configured to detect various types of deviations at block 310. An example deviation is a missing shift, which is a shift defined in the schedule data for which, at the start time of the shift, the corresponding worker 120 is indicated as being absent in the presence data. In other words, a missing shift deviation is a shift to which the assigned worker 120 has not appeared at the facility by the scheduled start time. As will be apparent, the worker 120 assigned to a missing shift may appear later (and therefore may be late for the shift rather than not appearing at all for the shift), or may not appear at all. The method 300 is executed substantially in real time, however, and it is therefore not yet known to the device 116 whether the worker 120 will appear later.

Another example deviation is a terminal deficit associated with a segment. A terminal deficit occurs when a worker 120 arrived for a shift to which that worker 120 was assigned, but the presence data indicates that the worker 120 has left the facility (e.g., clocked out) before the scheduled end time of the shift. The terminal deficit, in other words, is a deficit relative to the scheduled number of work hours for the corresponding shift. For example, if a shift is scheduled to run from 9 am to 3 pm, and the worker 120 assigned to that shift arrives at 9 am and leaves at 1 pm, there is a terminal deficit of two hours associated with the shift (“terminal” indicating that the deficit occurs at the end of the shift).

A further example deviation that can be detected at block 310 is an initial surplus, in which the presence data indicates that a worker 120 has arrived at the facility before the start time of a shift for that worker 120. In other words, the worker 120 has clocked in some period of time before they are scheduled to clock in, and the facility is staffed with a surplus of hours relative to the schedule. The surplus is referred to as “initial” because it occurs before the beginning of the shift.

A further example deviation is a terminal surplus, in which the presence data indicates that a worker 120 has not clocked out from the facility after a shift to which the worker 120 was assigned has ended. In other words, the worker 120 remains present at the facility after the end time of their shift.

The schedule data obtained at block 305 can also include historical schedule data, in addition to the schedule for a time period such as the current work day. From the historical schedule data, the device 116 can determine one or more schedule attributes, such as an average number of scheduled hours for the facility, e.g., for the workday, for portions of the workday, or the like. For example, if the current workday is a Tuesday, the device 116 can determine based on the historical schedule data that the average number of scheduled hours for Tuesdays is one hundred hours across all workers 120. The device 116 can further be configured to detect a deviation in the form of a Scheduled Shortage Relative to Usual (SSRU), which is a difference between the above average, and the actual number of scheduled hours for the current workday. For instance, if the total number of scheduled hours for the current Tuesday is ninety-one hours, the SSRU is nine hours. SSRU deviations can also be determined on an hourly basis, or for other suitable time periods, rather than on a daily basis.

The device 116 can also detect deviations in the form of unscheduled workers 120. An unscheduled worker 120 is a worker 120 that the presence data obtained at block 305 indicates is present at the facility, but to whom no shifts are assigned in the schedule data. In other words, an unscheduled worker 120 was not, according to the schedule data, expected to appear at the facility during the current workday (or other suitable schedule period).

The device 116 is thus configured to compare the schedule data and presence data, and in some examples historical schedule data, to detect any of the above-mentioned deviations. The data defining a deviation varies depending on the nature of the deviation. A missing shift deviation can be defined by a shift identifier. A terminal deficit deviation can be defined by a shift identifier and a number of hours and/or the early departure time for that shift recorded in the presence data. An initial surplus deviation can be defined by a shift identifier and a number of hours and/or early arrival time recorded in the presence data. A terminal surplus can be defined by a shift identifier, and in some instances a number of hours and/or departure time. As will be apparent, a number of hours or departure time may not be available for a terminal surplus, because the worker 120 may still be present at the facility. An unscheduled worker deviation can be defined by a worker identifier and, in some examples, an arrival time for the corresponding worker 120.

As noted earlier, the functionality implemented by the device 116 via execution of the application 236 permits the allocation of tasks to unscheduled workers 120 by dynamically generating auxiliary shifts for those workers (despite the schedule itself containing no shifts for unscheduled workers). At block 315, the device 116 is configured to determine whether the deviations detected at block 310 include any unscheduled worker deviations. When the determination at block 315 is negative, the performance of the method 300 can end. The device 116 can be configured to perform the method 300 periodically, e.g., every fifteen minutes (or after any other suitable time period), and the device 116 can therefore also return to block 305 after a negative determination at block 315.

When the determination at block 315 is affirmative, the device 116 proceeds to block 320. At block 320, the device 116 is configured to determine an end time for an auxiliary segment corresponding to the unscheduled worker 120 detected at block 310. When more than one unscheduled worker 120 was detected at block 310, the device 116 is configured to determine an end time for each unscheduled worker 120. The end time(s) from block 320, as described below, are determined based on the other deviations from block 310. The device 116 can, for example, be configured to match one or more other deviations (e.g., deviations that result in time deficits relative to the schedule) to an unscheduled worker 120. If a deviation is matched to the unscheduled worker 120, the device 116 can be configured to infer a time that the unscheduled worker 120 is likely to remain present at the facility, and therefore available for task allocations.

At block 325, the device 116 is configured to generate an auxiliary segment corresponding to each unscheduled worker 120 from block 310. Each auxiliary segment includes a start time based on the presence data (e.g., the arrival time of the unscheduled worker 120), and the end time determined at block 320. Each auxiliary segment also includes a worker identifier corresponding to the unscheduled worker 120. At block 330, the auxiliary segment(s) can be provided to the application 220 for task allocation, along with the schedule data and worker profile data. Task allocations can be communicated to the devices 128 in the form of notification messages or the like. The allocation of tasks at block 330 can be performed according to any suitable mechanisms that will occur to those skilled in the art, and task allocation is therefore not discussed in detail herein. It will be understood, however, that task allocation mechanisms that are dependent on schedule data defining shifts for workers can operate, with few or no modifications, on unscheduled workers as a result of the dynamic generation of auxiliary segments by the device 116.

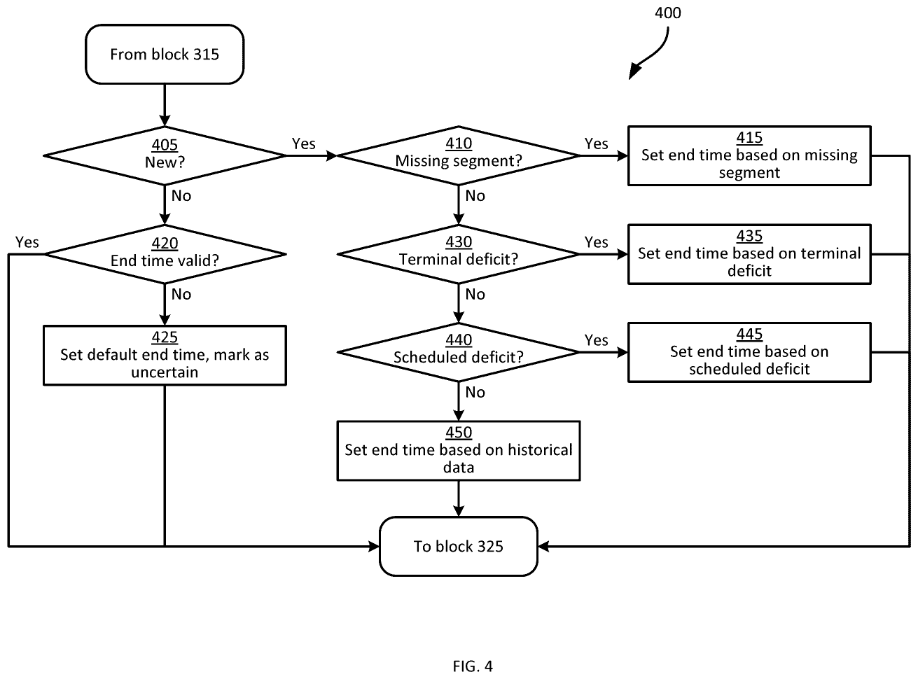

Turning to FIG. 4, an example method 400 of performing block 320 is illustrated. As noted above, the device 116 can perform block 320 by matching an unscheduled worker 120, based on the presence data associated with that unscheduled worker 120, with another deviation to determine a likely end time for the unscheduled worker 120 (e.g., a time the unscheduled worker 120 can be expected to remain at the facility). The device 116 can perform such matching via a performance of the method 400, which can be repeated for each unscheduled worker for a given performance of block 320.

At block 405, the device 116 is configured to determine whether the unscheduled worker 120 was newly detected at block 310, or whether the unscheduled worker 120 has been processed via the method 400 before. Because the method 300 is repeated periodically in some examples, an unscheduled worker detected at block 310 and assigned an auxiliary shift via blocks 320 and 325 may be re-evaluated at a subsequent performance of block 320.

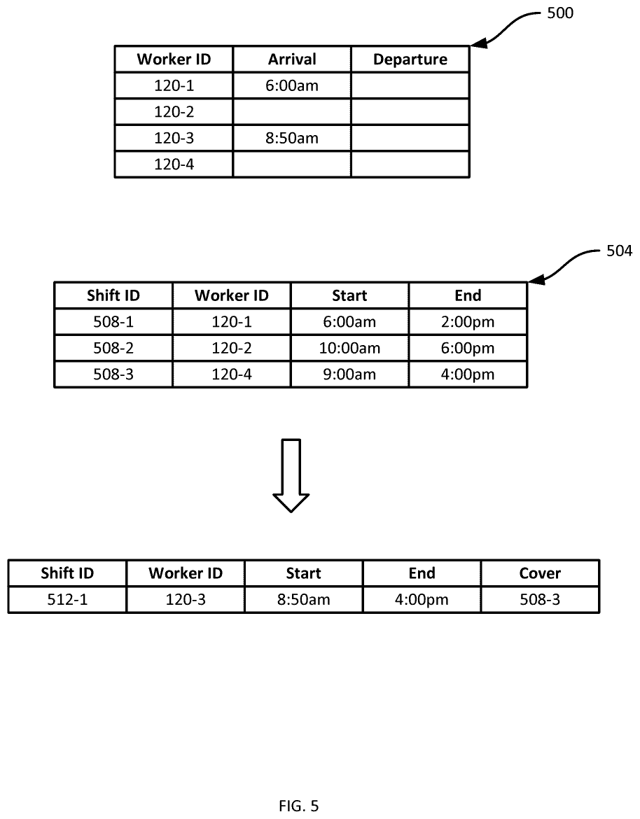

When the determination at block 405 is affirmative, indicating that no auxiliary shift has been generated for the unscheduled worker 120 (for the current schedule period, such as the current workday), the device 116 proceeds to block 410. At block 410, the device 116 can determine whether the deviations from block 310 include a missing segment. Turning to FIG. 5, an example set of presence data 500, and an example set of schedule data 504 are shown, e.g., as retrieved from the repositories 228 and 224 at block 305. The current time, in the example shown in FIG. 5, is 9:15 am. The presence data 500 indicates that workers 120-1 and 120-3 are present, having arrived at the facility at 6:00 am and 8:50 am, respectively. The workers 120-2 and 120-4 are not present at the facility.

The schedule data 504 indicates that three shifts 508-1, 508-2, and 508-3 are scheduled for the current workday, assigned to the workers 120-1, 120-2, and 120-4 respectively. As will be apparent from a comparison of the presence data 500 and the schedule data 504, the shift 508-3 is scheduled to begin at 9:00 am (fifteen minutes prior to the current performance of the method 300), but the corresponding worker 120-4 has not arrived at the facility. The device 116 therefore detects, at block 310, a missing shift in the form of the shift 508-3. As is also apparent from FIG. 5, the worker 120-3 is present at the facility, despite having no assigned shift in the schedule data 504. The device 116 therefore detects an unscheduled worker deviation at block 310, and the determination at block 315 is affirmative.

Returning to FIG. 4, the determination at block 410 is therefore affirmative in this example, and the device 116 proceeds to block 415. At block 415, the device 116 is configured to set an end time for an auxiliary segment corresponding to the worker 120-3 (the unscheduled worker in this example) based on the end time of the missing shift. The performance of block 415, in other words, infers that the unscheduled worker 120-3 is likely present at the facility to cover the missing shift, and is therefore likely to remain at the facility until the missing shift ends. Referring again to FIG. 5, an example auxiliary segment 512-1 is shown, as generated at block 325 following the selection of an end time at block 415. The auxiliary segment 512-1 is structured following a format that is similar to, or the same as, the segments 508 of the schedule data 504. The auxiliary segment 512-1 thus includes a worker assignment (in this case, the identifier of the unscheduled worker 120-3), and start and end times. The start time is based on the presence data 500, and in this example is equal to the arrival time of the unscheduled worker 120-3. The end time is based on a deviation (in this case, the missing shift 508-3), and in the illustrated example is equal to the end time of the missing shift 508-3. The auxiliary shift 512-1 can also include, as shown in FIG. 5, an indication of which deviation is likely being covered by the segment 512-1 (e.g., in this case, the shift 508-3).

When more than one missing shift is detected, at block 415 the device 116 can be configured to set an auxiliary end time for a given unscheduled worker 120 based on the oldest missing shift that has not yet ended (e.g., the missing shift with the earliest start time). In other examples, the device 116 can select the missing shift with the greatest length of time remaining. Other criteria for matching a missing shift to an unscheduled worker 120 will also occur to those skilled in the art.

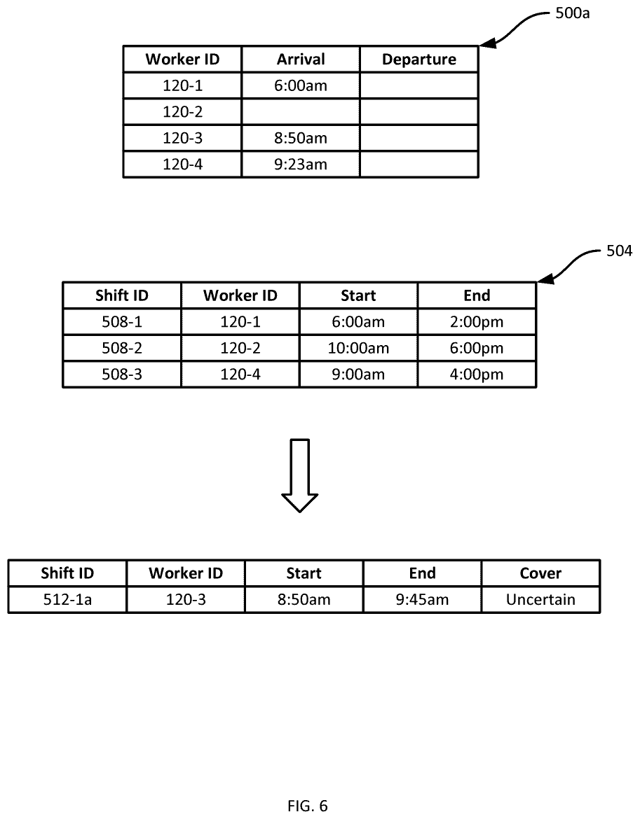

As shown in FIG. 4, following the setting of an end time, the device 116 returns to block 325. The device 116 can be configured to repeat the method 400 at a later time, e.g., when the next performance of the method 300 is initiated and deviations including unscheduled workers are detected at block 310. FIG. 6 illustrates a further set of presence data 500a, obtained by the device 116 at 9:30 am (e.g., fifteen minutes after the presence data 500 shown in FIG. 5. The schedule data 504 is also shown in FIG. 6, though it will be apparent that the schedule data 504 is unchanged. The presence data 500a indicates that the worker 120-4 arrived at the facility at 9:23 am. At block 310, the deviations detected therefore still include the unscheduled worker 120-3, but no longer include a missing shift, because the worker assigned to the shift 508-3 is present.

Referring back to FIG. 4, the determination at block 405 is negative, because an auxiliary segment (the segment 512-1) already exists for the worker 120-3. The device 116 therefore proceeds to block 420. At block 420, the device 116 is configured to determine whether the end time for the auxiliary shift 512-1 remains valid. Determining whether an auxiliary end point remains valid can include, for example, determining whether a previously missing shift is no longer missing. Determining whether an auxiliary end point remains valid can also include, in some examples, determining whether a concurrent surplus deviation was detected at block 310. In some implementations, surpluses can be preferentially matched to missing shifts, before setting end times for unscheduled workers.

When the determination at block 420 is affirmative, the device 116 proceeds to block 325 (or, if multiple unscheduled workers 120 were detected at block 310, the device 116 repeats the method 400 for each other unscheduled worker 120). In this example, the shift 508-3 is no longer missing, and the determination at block 420 is therefore negative. Following a negative determination at block 420, the device 116 proceeds to block 425. At block 425, the device 116 is configured to set an end time for the unscheduled worker 120-3 according to a default increment, e.g., from the current time. In this example, as shown in FIG. 6, the device 116 sets the end time for the auxiliary segment 512-1a (that is a modified version of the segment 512-1) that is fifteen minutes in the future (e.g., 9:45 am). The default increment can have other lengths of time, in other implementations. The segment 512-1a also no longer indicates that the worker 120-3 is likely covering the missing shift 508-3. Instead, the segment 512-1a can be assigned an “uncertain” status, or other suitable indicator that the segment 512-1a has not been matched to any specific deviation. Auxiliary segments with such indicators can be handled in the same way as new unscheduled workers in subsequent performances of the method 400 (e.g., leading to an affirmative determination at block 405).

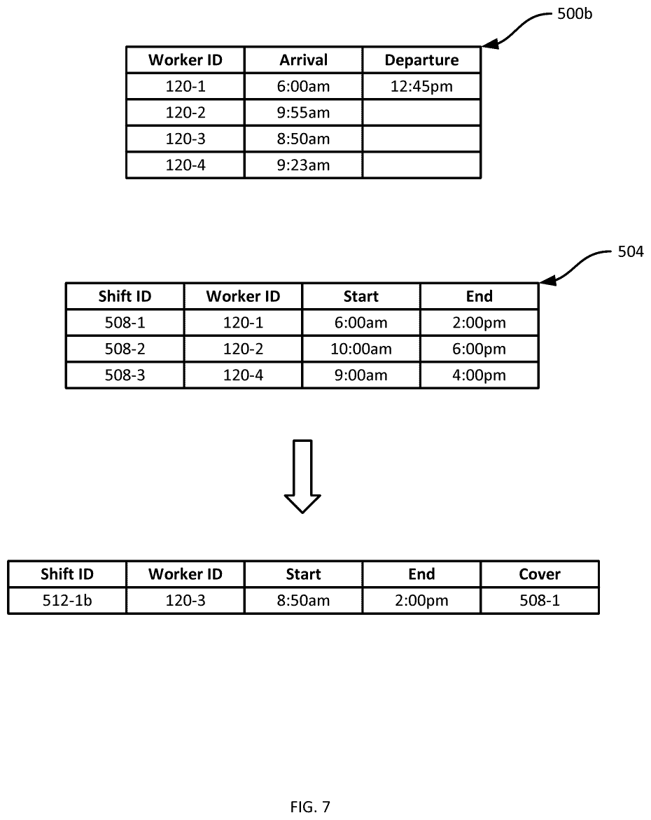

Turning to FIG. 7, a subsequent set of presence data 500b is illustrated, e.g., when the method 300 is performed at 1:00 pm. The presence data 500b indicates that the worker 120-1 left the facility at 12:45 pm, prior to the end of the shift 508-1. The device 116 can therefore detect a terminal deficit (of one hour and fifteen minutes in this example) corresponding to the shift 508-1 at block 310. The determination at block 410 in this example is negative (e.g., because no missing shifts were detected, although it is also possible that missing shifts were detected and have already been matched with other auxiliary segments), and at block 430 the device 116 determines whether a terminal deficit was detected. An affirmative determination at block 430 leads to block 435, at which the device 116 sets an end time based on the terminal deficit. FIG. 7 illustrates an example auxiliary shift 512-1b, in which the end time has been set to the end time of the shift 508-1.

Referring again to FIG. 4, in other examples, when no missing segments or terminal deficits are available to match to an unscheduled worker, at block 440 the device 116 can determine whether a scheduled deficit (e.g., an SSRU) was detected at block 310. When the determination at block 440 is affirmative, the device 116 can proceed to block 445, and set an end time for an auxiliary segment based on the detected SSRU. In some examples, the device 116 can assign the full length of the detected SSRU to one auxiliary segment. In other examples, the device 116 can assign a portion of the length of an SSRU period, e.g., up to a configurable limit (e.g., eight hours), to a given unscheduled worker 120. A remaining portion of an SSRU period can be assigned to one or more other unscheduled workers 120.

When the determination at block 445 is negative, at block 450 the device 116 can set an end time for an auxiliary segment based on historical presence and/or schedule data. For example, the device 116 can maintain auxiliary shifts in the memory 204, e.g., in the repository 228 as one or more statistical properties of unscheduled shifts associated with a given worker 120. The device 116 can therefore, at block 450, retrieve from the repository 228 an average length of auxiliary shift for the worker 120-3 when the worker 120-3 has been assigned auxiliary shifts in the past. In other examples, the device 116 can employ aggregated historical data rather than worker-specific data at block 450. For example, the device 116 can maintain, for various scheduled periods (e.g., each day of the week), the average length of auxiliary shifts occurring during those periods, and can use such an average length to determine an end time at block 450.

As will be apparent from the discussion above, the generation of auxiliary segments for unscheduled workers 120 permits the device 116 to supplement schedule data provided to the application 220 for task allocation. The supplementing of schedule data facilitates automated task allocation over a broader range of available workers, including those for whom the device 116 may otherwise be unable to automatically assign tasks.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, comprising:
obtaining schedule data for a facility, the schedule data including a plurality of segments, each segment having (i) a start time, (ii) an end time, and (iii) a worker identifier assigned to the segment from a plurality of worker identifiers;
obtaining presence data including, for each of the plurality of worker identifiers, whether a corresponding worker is present at a facility;
detecting, from the presence data, a worker present at the facility, having a first worker identifier that is not assigned to any of the segments in the schedule data;
generating an auxiliary segment having (i) a start time based on the presence data, (ii) an end time based on a comparison of the schedule data with the presence data, and (iii) the first worker identifier; and
providing the auxiliary segment to a task allocator with the schedule data.

2. The method of claim 1, further comprising:
at the task allocator, allocating a task to one of the worker identifiers based on the schedule data and the auxiliary segment; and
transmitting a notification to a client computing device corresponding to the one worker identifier.

3. The method of claim 1, wherein generating the auxiliary segment includes:
detecting, based on a comparison of the schedule data with the presence data, that a second worker identifier assigned to one of the segments corresponds to a worker not present at the facility; and
generating the end time for the auxiliary segment based on the end time to the one of the segments.

4. The method of claim 3, further comprising:
obtaining updated presence data subsequent to obtaining the presence data;
determining, based on the updated presence data, whether the end time of the auxiliary segment remains valid; and
when the end time of the auxiliary segment is invalid, generating a new end time for the auxiliary segment.

5. The method of claim 4, wherein determining whether the end time remains valid comprises:
determining whether the worker corresponding to the second worker identifier remains absent from the facility.

6. The method of claim 4, wherein generating the new end time for the auxiliary segment comprises: applying a default time increment to a current time.

7. The method of claim 1, further comprising:
detecting, based on the comparison of the schedule data with the presence data, a schedule deviation including a scheduled segment with a terminal deficit; and
generating the end time according to the end time of the scheduled segment with the terminal deficit.

8. The method of claim 1, further comprising:
obtaining historical schedule data;
detecting, based on a comparison of the schedule data and the historical schedule data, a current scheduled shortage relative to the historical schedule data; and
generating the end time according to the current scheduled shortage.

9. The method of claim 1, wherein the presence data indicates whether each worker is present at the facility via the presence or absence of an arrival time for the corresponding worker identifier.

10. A computing device, comprising:
a communications interface; and
a processor configured to:
obtain schedule data for a facility, the schedule data including a plurality of segments, each segment having (i) a start time, (ii) an end time, and (iii) a worker identifier assigned to the segment from a plurality of worker identifiers;
obtain presence data including, for each of the plurality of worker identifiers, whether a corresponding worker is present at a facility;
detect, from the presence data, a worker present at the facility, having a first worker identifier that is not assigned to any of the segments in the schedule data;
generate an auxiliary segment having (i) a start time based on the presence data, (ii) an end time based on a comparison of the schedule data with the presence data, and (iii) the first worker identifier; and
provide the auxiliary segment to a task allocator with the schedule data.

11. The computing device of claim 10, wherein the processor is further configured to:
allocate a task to one of the worker identifiers based on the schedule data and the auxiliary segment; and
transmit a notification to a client computing device corresponding to the one worker identifier.

12. The computing device of claim 10, wherein the processor is configured to generate the auxiliary segment by:
detecting, based on a comparison of the schedule data with the presence data, that a second worker identifier assigned to one of the segments corresponds to a worker not present at the facility; and
generating the end time for the auxiliary segment based on the end time to the one of the segments.

13. The computing device of claim 12, wherein the processor is further configured to:
obtain updated presence data subsequent to obtaining the presence data;
determine, based on the updated presence data, whether the end time of the auxiliary segment remains valid; and
when the end time of the auxiliary segment is invalid, generate a new end time for the auxiliary segment.

14. The computing device of claim 13, wherein the processor is configured to determine whether the end time remains valid by:
determining whether the worker corresponding to the second worker identifier remains absent from the facility.

15. The computing device of claim 13, wherein the processor is configured to generate the new end time for the auxiliary segment by: applying a default time increment to a current time.

16. The computing device of claim 10, wherein the processor is further configured to:
detect, based on the comparison of the schedule data with the presence data, a schedule deviation including a scheduled segment with a terminal deficit; and
generate the end time according to the end time of the scheduled segment with the terminal deficit.

17. The computing device of claim 10, wherein the processor is further configured to:
obtain historical schedule data;
detect, based on a comparison of the schedule data and the historical schedule data, a current scheduled shortage relative to the historical schedule data; and
generate the end time according to the current scheduled shortage.

18. The computing device of claim 10, wherein the presence data indicates whether each worker is present at the facility via the presence or absence of an arrival time for the corresponding worker identifier.
